(19) United States
(12) Patent Application Publication
(10) Pub. No.: US 2012/0266506 A1
(43) Pub. Date: Oct. 25, 2012

(54) MOUNTING AID FOR MOUNTING FILMS

(75) Inventor: Tarik Kirgiz, Rheine (DE)

(73) Assignee: CK-TECH GMBH & CO., Rheine (DE)

(21) Appl. No.: 13/497,570

(22) PCT Filed: Sep. 26, 2010
(86) PCT No.: PCT/DE10/75097

§ 371 Date: Mar. 22, 2012

(30) Foreign Application Priority Data
Sep. 29, 2009 (DE) 10 2009 043 361.9

(51) Int. Cl. G09F 11/21; F16B 47/00

(52) U.S. Cl. 40/514; 248/205.8

(57) ABSTRACT

A mounting aid (1) for mounting films (2), in particular advertising or decorative films on planar substrates, e. g. windows, by unwinding the film (2) from a core (3), designed in such a way that said mounting aid (1) comprises two stationarily supportable fixing devices (4) to hold the core (3) relative to the substrate with the core (3) being rotatable relative to the fixing devices (4).

This application claims priority under 35 USC 365(a) to International Patent Application No. PCT/DE2010/075097 having an International Filing Date of Sep. 26, 2010 which is incorporated herein by reference in its entirety.

### I. BACKGROUND OF THE INVENTION

A. Field of Invention

Some embodiments may relate to a mounting aid for mounting films, in particular advertising films, typically with textual and visual content.

B. Description of the Related Art

Such films are used particularly in advertising, trade fair construction, for window and facade displays, and on vehicles. Films are widely used for a variety of applications and typically comprise three layers: the base layer is a backing sheet to which the actual self-adhesive film to be mounted on a substrate is glued. From this self-adhesive film sections are cut out and removed using a plotter or cutting device in a preparatory step so that only the desired graphic elements remain on the backing The cut-out film is then ready to be transferred to the display substrate. Traditionally, this transfer is effected with the help of a transfer foil which is typically transparent and has a self-adhesive underside. The transfer foil is supplied on a roll-shaped core and available in different lengths and widths. When selecting the format of the transfer foil, it must be ensured that the entire film web can be covered by one piece said transfer foil. Typically, the work surface is horizontal. On the work surface the film web consisting of backing and graphic elements is laid out with the cut-out graphic elements pointing up. Now the transfer foil is unwound from one side of the work surface to the extent that it covers the entire film web. In a subsequent step, the transfer foil with its adhesive underside can be successively glued onto the film web beneath it to fabricate a bubble-free triple-layer film.

To mount said triple layer film, it is positioned on the substrate and secured, e. g. with adhesive tape. Next, the backing is removed from the film to be mounted on the substrate by gradually pulling sections of the backing off the self-adhesive film and transferring the exposed section of the self-adhesive film to the substrate. During this step, the transfer foil ensures that the arrangement of the graphic elements to be transferred remains intact. The film is transferred section by section until the entire sheet is fully glued to the substrate. In a last step, the transfer foil covering the film that is now attached to the substrate is removed.

The disadvantages resulting from the procedure described above are known to the film mounting trade. Depending on the width of the film to be applied several employees are required to affix the transfer foil in the preparatory step, to align it on the display substrate, to remove the transfer foil and finally to attach the self-adhesive film, thereby ensuring a crease-free planar application. In other words, it involves a significant amount of time and personnel resources and yet unwanted contact between the various film layers or between the film and the substrate cannot be ruled out, or the film may be positioned incorrectly or creased, which results in significant additional costs since the film has to be removed from the substrate, is generally unusable afterwards and must be reproduced and reinstalled.

Some embodiments of present invention may provide a mounting aid to facilitate easy and secure processing and application of films and/or may solve one or more of the above drawbacks of the known art.

### II. SUMMARY OF THE INVENTION

Some embodiments may provide a mounting aid which substantially eases the application of films on planar substrates, e. g. windows. Since the mounting aid comprises two stationarily supportable fixing devices to hold the core from which the film is unwound relative to the substrate, the core being rotatable relative to the fixing devices and holding the film can be of any width. Both fixing devices can be connected to the core independently from one another and thus facilitate a high level of flexibility with regard to the length of the core.

Due to the supportability of both fixing devices relative to the substrate, the film may be held on the substrate without the help of the installer(s).

With the fixing devices each having a support element extending axially and parallel to the core on which the core is rotatably held relative to the substrate, the film can easily be connected to the two support elements via its core and unwound despite the fixing devices' stationarily supported function.

The core typically includes a hollow cylinder cardboard roll whose axial ends are slipped over the axially extending support elements. Particularly strong retention and tolerance compensation for the inner diameter of the core is achieved with the support elements widening in an axially outward taper, thus allowing for the core to slide on until a secure fit is ensured. A varying overall width of the core and lateral fixing devices is not an issue because the two fixing devices are independent from one another.

In particular, the fixing devices each comprise a ring retainer in which the support elements are rotatably held and supported evenly and mechanically stable across their circumference. Positioned in this ring retainer, the support elements are manually rotatable via externally accessible grips.

The possibility to rotate the core relative to the fixing devices on the one hand and to restrict this rotary motion via a brake or locking mechanism on the other hand, not only allows an operator to hold the film to the substrate but also to unwind it partially or fully in the stationarily supported position of the fixing devices.

In particular, the brake or locking mechanism to restrict the rotary motion is adjustable and thus allows for different roll-off resistance settings—depending on the operator's preference and the size of the film—as well as fine-tuning to compensate for wear.

It is especially favorable that the fixing devices are constructed identically and interchangeably so that the operator is not required to determine which fixing device to attach to the left and right side of the core, thus speeding up the work process.

In some embodiments, the fixing devices can comprise two plastic components each, namely a first component forming a ring retainer and a second forming a rotatable support element. During installation, this support element is inserted into the ring retainer axially from the outside and secured against axial extraction, e.g. via a ridge on the axially inward pointing part of the support element. This ridge can also be applied (welded on) after the support element is inserted.

Each fixing device may be advantageously provided with at least one fixing element for the indirect or direct attachment to the substrate, e. g. a suction cup, so that the two fixing devices can be attached successively and completely independently of one another.

In this context, each of the fixing devices may be advantageously equipped with at least one adjustment aid for proper horizontal and/or vertical surface adjustment, e. g. two or more levels.

Fixing devices for a mounting aid according to the claimed invention are interchangeable and therefore are named collectively in the claims.

Other benefits and advantages will become apparent to those skilled in the art to which it pertains upon reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 shows a schematic, slightly perspective view of a mounting aid according to the invention with a core holding a film being held by lateral fixing devices;

FIG. 2 shows a detailed view of one lateral fixing device with the core attached, roughly corresponding to Detail II in FIG. 1;

FIG. 3 shows a similar view as FIG. 2, however subsequent to the axial removal of the core from the support element with an arrow indicating the rotatability of the support element; and

FIG. 4 shows a similar view as FIG. 3, however with the additionally marked external lateral recessed grips for manually rotating the support element and film held on the core, which, after slipping the core over the support elements, can be unwound relative to the stationarily supported fixing devices.

### IV. DETAILED DESCRIPTION OF THE INVENTION

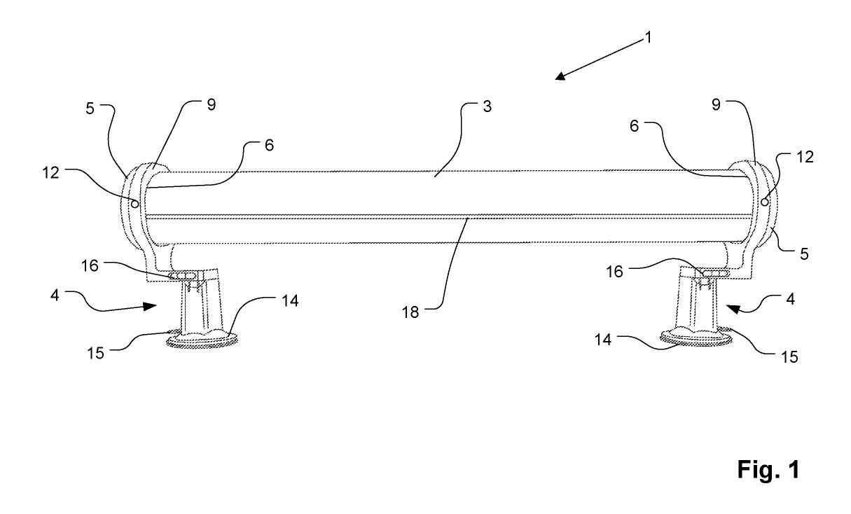

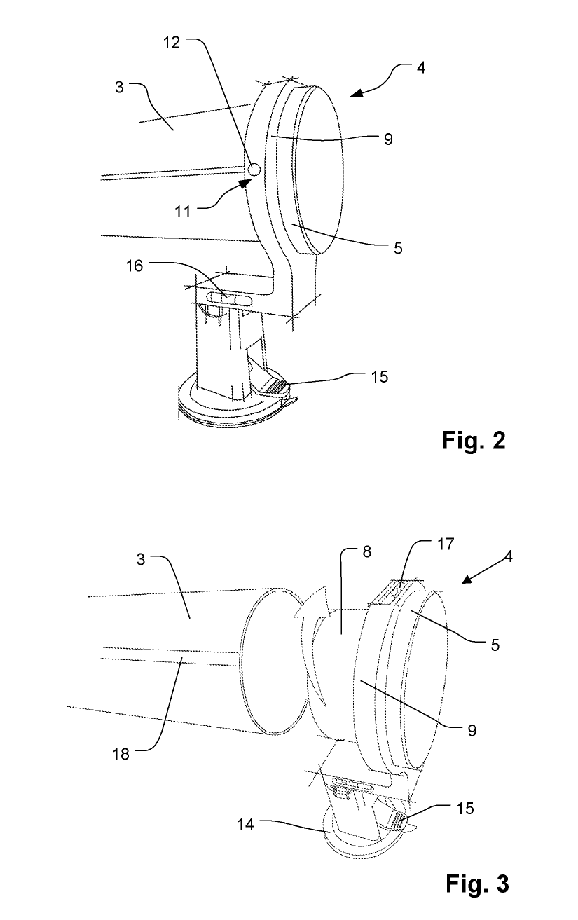

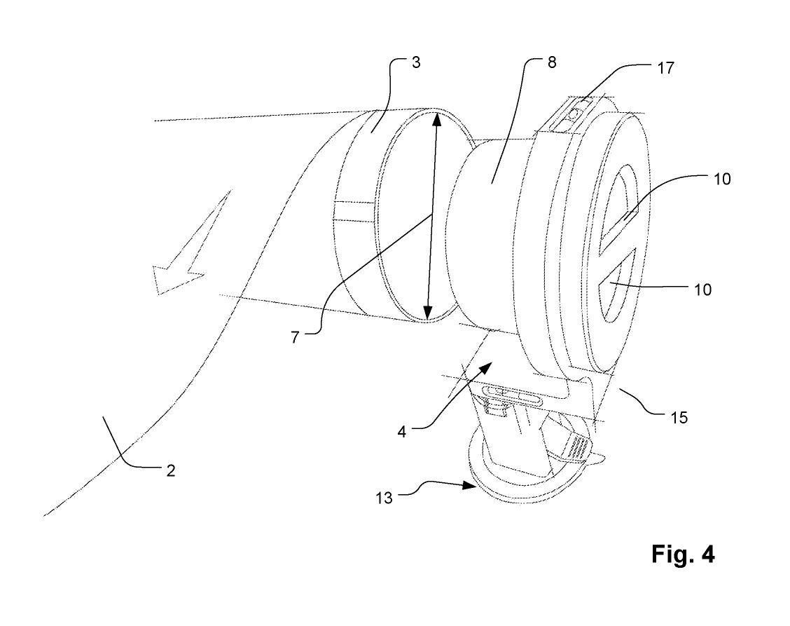

A function of the mounting aid schematically illustrated in FIG. 1 and here generally referred to as 1 is to apply transfer foil onto cut-out elements on a backing sheet in the preparatory phase for one, and secondly to mount films 2, in particular advertising, tinted or decorative films, on planar substrates, e. g. windows. Such films, e.g. PVC films, are typically used for showroom displays but can also be seen on car windows or other mobile units.

The film 2 is typically multi-layered and in this example comprises a backing for transport protection as well as a self-adhesive film which itself can be multi-layered as well and comprise a layer with the actual decor or text, perhaps in a mirror-inverted arrangement, and a transfer foil covering it.

To prepare the mounting aid 1 in a first step, the completed (i.e. plotted and trimmed) film 2 covered with a transfer foil is wound on a core 3 which is typically a cardboard tube having an inner diameter of approximately 70 to 80 millimeters. To avoid sloping when winding the film 2 onto the core 3, an optical mark 18 is provided on the face of the core 3 according to an embodiment to which the edge of the film 2 is to be aligned for the winding process. The optical mark 18 runs parallel to the longitudinal axis of the core 3.

In some embodiments, it may also possible to wind up several films next to one another on the core 3 (not depicted). For this purpose, separators several centimeters wide can be inserted between the individual film rolls. These multiple film rolls can then be unwound onto a substrate simultaneously and parallel to each other. A length scale can be drawn or glued onto the core 3. In such a case, the film 2 does not need to be wound flush with the edge but can be wound with a defined edge spacing corresponding to that of the substrate.

For the gluing step, the film 2 is unwound from the core 3. For this to be comfortable for and manageable by only one employee the mounting aid 1 comprises two directly or indirectly stationarily supportable fixing devices 4 relative to the substrate. In a mounted configuration, these are located at the axial ends 6 of the core 3 which is connected to the rotatable elements 5, namely the support elements 5 holding the core 3 via connecting pieces 8, thus allowing the core 3 to rotate on the fixing devices 4 around its longitudinal axis.

In a mounted configuration, the support elements 5 extend axially and parallel to the attached core 3 into which they engage. The rotationally symmetric support elements 5 having tapered connecting pieces 8 relative to the axial extension of the core 3 can thus accept and hold securely different inner diameters 7 of a hollow cylinder shaped core 3. Therefore, depending on the inner diameter 7, the core 3 with its axial ends 6 can be slipped over the axially extending support elements 5 at different lengths until a secure retention is achieved, thereby allowing for varying widths of the mounting aid 1 based on the width of the core 3 and its inner diameter 7.

Due to the independently placed fixing devices 4, a width variation is not a problem. Therefore, there are no strict requirements regarding the dimensional accuracy of the core 3 which is typically a cardboard tube. It can even be cut to length and squared on-site.

Instead of tapered support elements 5, components with radially interlocking spring clamps or stepped support elements or other options allowing for tolerance adjustments with regard to the inner diameter of the core 3 can be used.

According to the illustrated example, the fixing devices 4 can each comprise one open or closed ring retainer 9 in which the support elements 5 are rotatably held. In operation, the ring retainer 9 itself can be stationarily supported on the substrate to which the film 2 is to be mounted. The rotatable support elements 5 in the ring retainer in this example are held by a friction bearing which is very cost-effective, but other bearing types are possible as well.

The rotation of the support elements 5 is not only effected by pulling the film 2 and core 3, but can also be manually done via the recessed grips 10 accessible from the outside, in particular to facilitate the ability to rewind sections of the film 2 that were unwound too far. Instead of the recessed grips 10, a crank or similar handle is possible as well.

To avoid unwinding the film 2 too far and/or too fast during the application on a window or similar substrate, a brake or locking mechanisms 11 (roll-off resistance) may be provided for each fixing device 4 to restrict the rotary motion of the support elements 5 relative to the ring retainers 9.

In this example, the brake or locking mechanism 11 comprises a set screw 12 which is screwed in perpendicular to the perimeter of the ring retainer 9 and strikes the glide surface of the support element 5 held by the ring retainer 9 with its screwed in tip (blunt in this example), thus reducing the rotary speed of the support element 5 relative to the ring retainer 9. The roll-off resistance can be adjusted by tightening the set screw 12 or loosening it respectively. Retorquing to compensate for wear is possible as well. Other roll-off resistance mechanisms, e.g. via dragging spring clamps or similar, can also be used. In this example, both fixing devices 4 are completely identical and thus interchangeable. This eases and accelerates the application process for the installer significantly and application failures are virtually impossible. Furthermore, the fixing devices 4 as well as the set screw 12 can easily and cost-effectively be fabricated from plastic. In that, a first plastic component forming the ring retainer 9 and a second forming the support element 5 can be injection molded parts.

When fabricating the fixing devices 4, the support elements 5 are inserted into the ring retainers 9 from the axial outside and secured against axial extraction. For example, this safeguard can be applied by welding on a ridge along the circumference of the part to prevent extraction of the support elements 5 from the ring retainers 9.

To ensure a comfortable operation of the mounting aid 1, each fixing device 4 may be equipped with at least one fixing element 13 for the direct or indirect attachment to the substrate 3. In this example, a suction cup 14 is provided as fixing element 13, which is affixed or loosened via a switch 15, comprising a switchable leverage actuator. With these fixing elements 13 the fixing devices 4 can directly be attached to the substrate so that the mounting aid 1 thus secured allows for easy unwinding and gluing of the film 2 to the substrate by only one person.

In order to ease the placement of the mounting aid 1 when attaching the two fixing devices 4 at each end of the unit for one installer, the two fixing devices are each equipped with at least one adjustment aid 16, 17 for proper horizontal and/or vertical surface adjustment. In this example, each fixing device 4 is equipped with two levels 16 for the horizontal and one level 17 for the vertical surface adjustment so that the fixing devices 4 can be interchanged as needed. An adjustment aid with an integrated laser level is possible as well. This would allow for measuring the space to the left and right edge of the window and exact center placement of the film 2 on the substrate. The top and bottom spacing to position the upper edge of the film 2 can also be measured to ensure exact placement on the surface. In its mounted state, the film 2 does not have to begin at a lateral or upper edge.

A fixing device 4 having a ring retainer 9 in which a support element 5 is rotatably held and secured in an axial direction, with the support element 5 being designed to provide non-positive and form-locking support for a core (roll) 3 and the rotation of the support element 5 in the ring retainer 9 being adjustable via a brake or locking mechanism 11 is separately tradable, also as spare part for said mounting aid 1. Since the core 3 is typically supplied with the film 2 it suffices to provide two such fixing devices 4 as a mounting aid 1, which are connected via the core 3.

For an application, the fixing devices 4 can be individually positioned and releasably attached by only one person, even with film widths exceeding one meter. And the unwinding of the film 2 from the core 3 restricted by the brake mechanism 11 and gluing the film 2 to the substrate can also easily be done by one person. The unwinding motion can be interrupted at any time in order to smooth an applied section of the film 2 before unwinding and gluing the next section. This ensures that the installer only unwinds as much film 2 as he/she can apply smoothly and crease-free.

To properly trim an overlong film a cutting device, e. g. an engaging cutting roll, can be provided. For many applications, the film 2 can also be applied flush to the edge of a substrate. This is made possible in that the film 2 can be wound over the entire length of the core 3 between the lateral fixing devices 4. Embodiments of the invention may not only allow for a top to bottom application by one person, but also a horizontal placement due to the second alignment aid 17 with a vertically positioned core 3.

The embodiments have been described, hereinabove. It will be apparent to those skilled in the art that the above methods and apparatuses may incorporate changes and modifications without departing from the general scope of this invention. It is intended to include all such modifications and alterations insofar as they come within the scope of the appended claims or the equivalents thereof

Having thus described the invention, it is now claimed:

I/we claim:

1. A mounting aid (1) for mounting films (2), in particular advertising or decorative films on planar substrates, by unwinding the film (2) from a core (3), the mounting aid comprising:
two stationarily supportable fixing devices (4) for fixing a core (3) relative to a substrate with the core (3) being rotatable relative to the fixing devices (4), wherein the fixing devices (4) each have a ring retainer (9) in which the support elements (5) are rotatably held.

2. The mounting aid (1) according to claim 1, wherein the fixing devices (4) each comprise a support element (5) extending axially and parallel to the core (3) on which the core (3) is rotatably held.

3. The mounting aid (1) according to claim 2, wherein the core (3) is designed as a hollow cylinder and its axial ends (6) can be slipped over the axially extending support elements (5).

4. The mounting aid (1) according to claim 3, and wherein the support elements (5) enlarge conically outward in axial direction.

5. The mounting aid (1) according to claim 1, wherein the support elements (5) are manually rotatable via externally accessible grips (10) to wind the film (2) on the core (3).

6. The mounting aid (1) according to claim 1, wherein a brake or locking mechanism (11) is provided to restrict the rotary motion of the support elements (5) relative to the ring retainers (9).

7. The mounting aid (1) according to claim 6, wherein the brake or locking mechanism (11) to restrict the rotary motion is adjustable.

8. The mounting aid (1) according to claim 1, wherein the fixing devices (4) are identical and interchangeable.

9. The mounting aid (1) according to claim 1, wherein the fixing devices (4) consist of a first plastic component forming the ring retainer (9) and a second plastic component forming the support element (5).

10. The mounting aid (1) according to claim 1, wherein in operation the support element (5) is inserted into the ring retainer (9) from the axial outside and secured against axial extraction.

11. The mounting aid (1) according to claim 1, wherein each fixing device (4) is equipped with at least one fixing element (13) for direct or indirect attachment to the substrate.

12. The mounting aid (1) according to claim 1, wherein the support elements (5) are provided with at least one adjustment aid (16, 17) for proper horizontal and/or vertical placement relative to the substrate.

13. The mounting aid (1) according to claim 11, wherein the fixing elements (13) can be directly affixed to the substrate.

14. The mounting aid (1) according to claim 13, wherein the fixing elements (13) comprise suction cups.

15. Fixing devices (4) for a mounting aid (1) according to claim 1, wherein said fixing device (4) comprises a ring retainer (9) in which a support element (5) is rotatably held and axially secured, whereby said support element (5) is designed to provide non-positive and form-locking support for a core (3) and the rotatability of the support element (5) relative to the ring retainer (9) is adjustable via a brake or locking mechanism (11).

16. A stationarily supportable fixing device (4), comprising:
a fixing element (13) comprising a suction cup adapted to fixedly engage a planar substrate;
a switchable leverage actuator (15) in mechanical communication with the fixing element (13) adapted to engage and disengage the fixing element (13) from the planar substrate;
a ring retainer (9) having a generally annular portion adapted to retain a rotatable support element (5) in a rotational relation relative to the ring retainer (9), the ring retainer (9) being in a permanently fixed relation with the fixing element (13); and
the rotatable support element (5) including a plurality of radii for receiving cores (3) of various diameters (7).

17. The device of claim 16, wherein the rotatable support element (5) comprises a structural feature for retaining cores of various sizes, the feature being selected from one or more of a generally conical shape, radially interlocking spring clamps, or stepped support elements.

18. The device of claim 16, further comprising a brake (12) and/or locking mechanism adapted to engage the rotatable support element (5) in a fixing relation to stop and/or slow the rotation of the rotatable support element (5).

19. The device of claim 16, further comprising at least one leveling means (16, 17) for reading the orientation of the device, the leveling means being selected from one or more of a bubble level or a laser level.

20. A mounting aid (1), comprising a pair of fixing elements (4) as defined in claim 16 arranged in an opposing configuration and each of the pair of fixing elements (4) engaging opposing ends of a core (3) in a rotatable relation.
